(19) United States
(12) Patent Application Publication
(10) Pub. No.: US 2002/0087631 A1
(43) Pub. Date: Jul. 4, 2002

(54) Email-based advertising system

(76) Inventor: Vikrant Sharma, Nevillewood, PA (US)

Correspondence Address: John W. McIlvaine, 700 Koppers Building, 436 Seventh Avenue, Pittsburgh, PA, 15219-1818, US

(21) Appl. No.: 10/038,126

(22) Filed: Jan. 2, 2002

Related U.S. Application Data
(60) Provisional application No. 60/259,453, filed on Jan. 3, 2001.

(51) Int. Cl. G06F 15/16

(52) U.S. Cl. 709/203; 709/206

(57) ABSTRACT

A system and method for delivering email-based advertising between computer users including a first computer, a second computer, and a server in a distributed computer network where the first computer is configured to transmit an email message to a second computer. The email message comprises an affiliate I.D. number and optionally one or more email client objects. The affiliate I.D. number uniquely identifies a user of the first computer. The second computer is responsive to the email message, whereby the second computer is configured to transmit the affiliate I.D. number and optionally one or more of the email client objects to the server. The server is responsive to the affiliate I.D. number and optionally one or more of the email client objects, by selecting an appropriate advertisement. The server is configured to transmit the advertisement to the second computer where the second computer displays the advertisement in the text window of the email message.

### BACKGROUND OF THE INVENTION

1. Field of the Invention

This invention relates to advertising over the Internet and, more particularly, advertising which takes place in conjunction with sending or receiving electronic mail messages (“Email”).

2. Description of the Prior Art

Internet users are constantly bombarded with “spam” (mass email advertising) and web site banner advertising, yet the effectiveness of both methods has been continuously declining. What was once thought of as a cash cow for web sites—online banner advertising—has simply not lived up to its predictions. Many business plans were based on bringing users to a particular site to generate revenues from advertising. In reality, these businesses found that attracting users to a site has been a difficult task and that, over time, the cost of advertising has declined significantly. The standard methods of attracting users and selling advertisement along with their problems are the following:

1. Web Site Banner Advertisement

Banner advertisement has seen its effectiveness decline over the last few years. This has been due to the fact that many users find them annoying and place a “mental filter” when viewing web sites. Thus, most banner advertisements are rarely noticed. In addition, it is difficult to accurately determine the user viewing the advertisements.

2. Mass Email Advertisement

Most users find impersonal, mass email advertisement to be rude and annoying and have thus named it “spam.” Pursuant to 47 U.S.C. § 227 “spamming” is becoming limited and, it is believed, will be phased out in the next few years. In addition, numerous virus attacks have left users in fear of opening email that is not from a familiar source. Users simply delete emails from unknown sources after reading the “subject” line.

FIG. 1 is a screen shot of a typical prior art email as seen by the recipient. Note, there is no advertisement in the text field.

FIG. 2 is an email message as viewed by a recipient who utilizes an advertisement based email service. Note, the advertisement is in the form of a banner position at the top of the screen. As discussed above, this sort of banner advertisement has been the subject of “mental filters,” email users simply tuning them out.

It is therefore an object of the present invention to overcome the above problems by dynamically embedding advertisements within emails that are sent in the “person-to-person” email space. It is a further object of the invention to provide a system for better tracking the demographics of Internet advertising, and also to enhance targeted advertising on the basis of the subject line of an email message. Finally, it is an object of the invention to provide a new revenue generation model for use in connection with email and advertising. Still other objects will become apparent to those of ordinary skill in the art upon reading and understanding the following detailed description.

### SUMMARY OF THE INVENTION

Accordingly, we have invented a method of delivering email-based advertising within a “person-to-person” email space, operating on the principles of a commission and demographic tracking system, and utilizing a partner computer, a recipient computer, and a server in a distributed computer network. A proprietor provides an affiliate I.D. number to a partner, which uniquely identifies the partner. The proprietor also provides software, which is configured to modify an email client of the partner. This modification causes the partner email client to transmit the affiliate I.D. number and optionally one or more email client objects whenever an email message is sent from the partner computer. Upon receiving and opening the email message, the recipient computer transmits the affiliate I.D. number and optionally one or more of the email client objects to a server. The server, maintained by the proprietor, comprises a database of commission, demographic, and advertising information. The server is responsive to the affiliate I.D. number and optionally one or more of the email client objects by selecting an appropriate advertisement as a function of the affiliate I.D. number and optionally one or more of the email client objects. The server optionally associates an active link with the advertisement prior to sending the advertisement to the recipient computer. The recipient computer receives the advertisement and then displays the advertisement within a recipient email client window. At a predetermined time, the server utilizes the partner's affiliate I.D. and associated information relating to the amount of advertisements transmitted, in order to determine the payment due to the partner.

While described in connection with a server transmitting an advertisement to an email client, the present invention can also be used with instant messaging software. It should be appreciated that the present invention can also be applied to wireless communication devices, for example, cellular phones employing WDMA technology.

The foregoing and other features of the method of the present invention will be further apparent from the description which follows.

### BRIEF DESCRIPTION OF THE DRAWINGS

FIG. 1 is a screen shot of a prior art Email Client message window, with no advertising included in the message field;

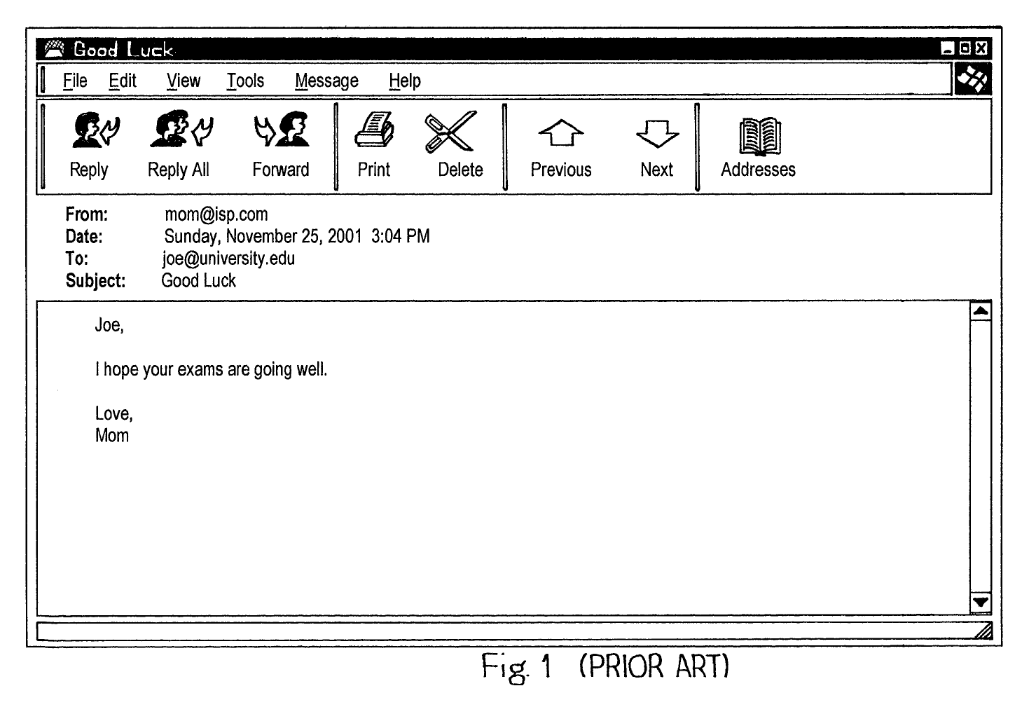

FIG. 2 is a screen shot of a prior art email message, which utilizes conventional banner advertisement located outside of the message field for the email message;

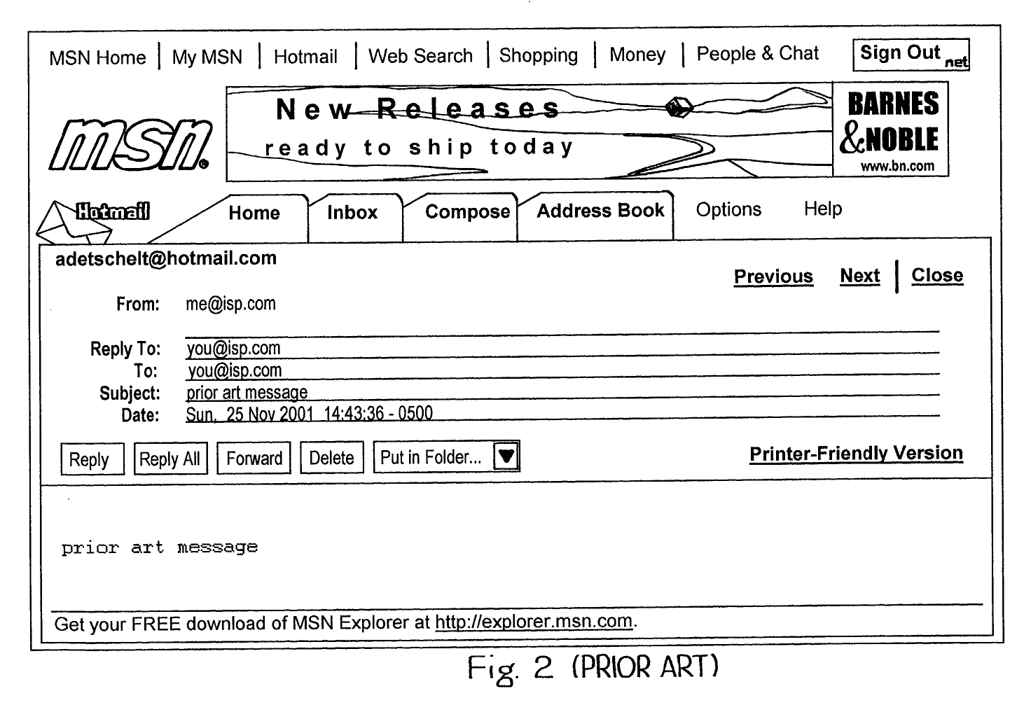

FIG. 3 is a screen shot of a Partner's Email Client message window prior to the email message being sent according to the present invention;

FIG. 4 is a screen shot of a Recipient's Email Client message window after receipt of an email message according to the present invention with advertising included in the message field; and

FIG. 5 is a schematic view of a system according to the present invention.

### DETAILED DESCRIPTION OF THE PREFERRED EMBODIMENTS

The invention is best understood in connection with the following definitions:

1. The Partner: an email user who has partnered with the Proprietor of the present invention to provide space within his/her regular email messages for advertising.

2. The Advertiser: the party that pays the Proprietor to have their advertisements embedded and seen by the Recipients.

3. The Recipient: the viewer of the email sent by the known Partner.

4. The Proprietor: the facilitator of the process; providing the technology, paying the Partners, hosting the server or servers to generate and manage the advertisements, and billing the advertiser.

5. Email Client: Microsoft Outlook, Microsoft Outlook Express, Netscape, AOL, Yahoo, Hotmail, Eudora Pro, Lotus Notes, etc.

6. Module: the program the Partner downloads which modifies their Email Client.

7. Banner Server: the web-server hosted by the Proprietor that serves the advertiser's banners to be embedded in the Partner's email message.

8. Person-to-Person email space: email messages sent and viewed between mutually known persons, as opposed to unsolicited advertising sources.

By way of overview, a process according to the present invention begins with an individual email user registering himself/herself as a Partner of the Proprietor on the Proprietor's web site. After registering, the Partner downloads a Module that will modify whatever Email Client the Partner is using. The downloaded Module, once installed, will enable the Email Client to insert HTML code within the Partner's email prior to sending the email message. This code enables the email, during the time of reading, to pull an advertisement from the Banner Server.

As the Partner writes and sends email, he/she is paid by the Proprietor on a per banner, per unique view, and per month basis. The process may be completely invisible to the Partner as he/she goes about his/her daily normal email reading and writing procedures.

The present invention enables tracking the Partner, the Recipient, and the geographical location by IP address. The present invention also enables targeted advertising based on the subject line of the email message. For example, if the subject line is “Happy Birthday,” the Banner Server might send an ad for Hallmark®. As more and more Partners are signed on, the base of Partners may be offered to advertisers. Payments from the advertisers will be the source of revenue for the Proprietor.

Partners will be compensated for allowing the Proprietor to insert banners in their private email space. To prevent Partners from engaging in spamming to falsely increase their email count, a limit on the total compensation per partner per month (for example, $500.00) may be instituted. The number of Partners will also be limited at times depending on the number of advertisers who have agreed to subscribe to the service.

Advertisers may be billed on an annual contract basis, for example, with a minimum requirement of 100,000 unique emails per month at a cost of $5,000.00 per hundred thousand unique emails.

The advertisements may also be arranged so that they are “clickable,” i.e., taking the Recipient directly to the advertiser's web site, if clicked.

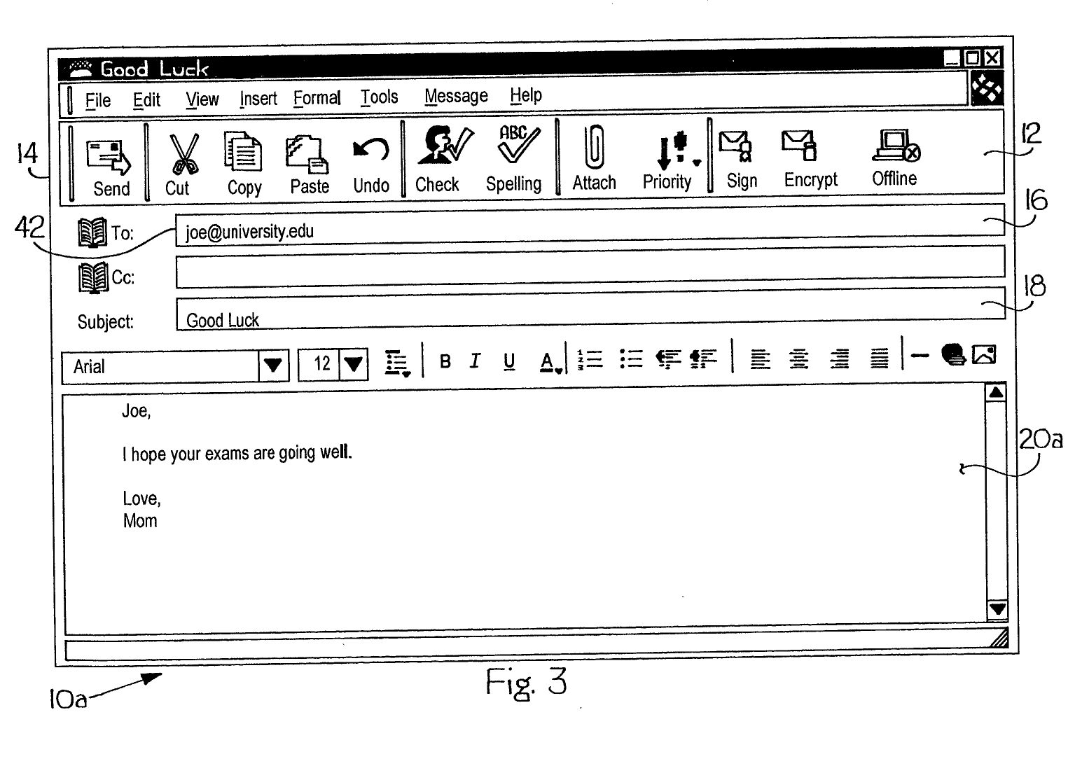

Referring to FIG. 3, a screen shot of a typical Partner Email Client message window 10a is shown, according to the present invention. Particularly, a toolbar 12 including a “Send” button 14 is located near the top of the Partner Email Client message window 10a. Below the toolbar 12 is a “To” field 16, as well as a “Subject” field 18. A Partner message field 20a is located below the “Subject” field 18.

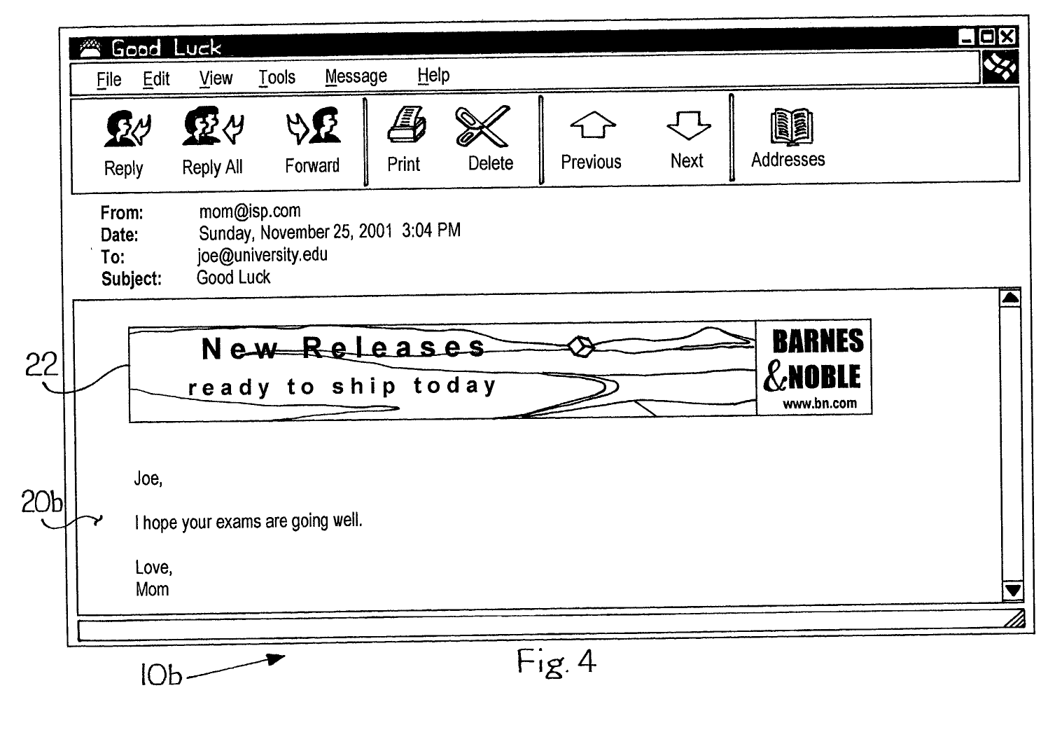

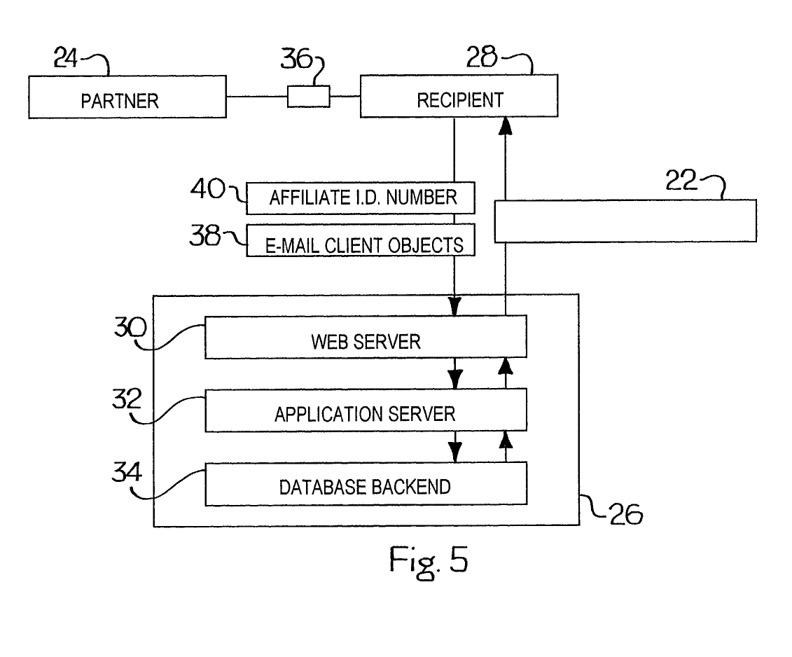

With reference to FIGS. 4 and 5, and with continuing reference to FIG. 3, a Partner 24 hits his/her “Send” button 14, after typing a message in the Partner message field 20a. As discussed in further detail below, prior to being sent, the email messages are embedded with HTML code, comprised of the Partner's unique I.D. No. 40, Email Client objects 38 (for example, a “Subject” line), etc. The Partner's Email Client sends the resultant email message 36 to the Recipient 28. The Recipient (or viewer) 28 receives the email message 36 with the embedded HTML code, resulting in an advertising banner 22 being “pulled” from a Banner Server 26, and being displayed in the Recipient Email Client message window 10b, more specifically, in the Recipient message field 20b, as is shown in FIG. 4. The advertising banner 22 may be in the form of a JPEG file, Macromedia® “Flash” animation file, etc., as will be apparent to those skilled in the art. Furthermore, the Banner Server 26 may be configured so that depending on the “Subject” matter indicated in the “Subject” field 18 of the email message 36 sent by the Partner 24, a suitably tailored advertisement is inserted in the Recipient message field 20b (for example, if the subject field 18 includes the terms “Happy Birthday,” then the Banner Server 26 could be programmed to insert an ad for Hallmark® greeting cards).

Thus, the advertising banner 22 is dynamically conveyed to the Recipient 28, simply by virtue of the Partner 24 clicking their “Send” button 14, providing advertising within the “Person-to-Person” email space. Viewing the process and system according to the invention in more detail, a person wishing to become a Partner 24 proceeds to the web site of the Proprietor and registers to become a commissioned Partner 24. At this time, the Partner 24 also downloads a program to modify the Partner's existing Email Client (for example, Microsoft Outlook Express, Netscape, AOL, Yahoo, Hotmail, Eudora Pro, etc.) allowing the Partner's Email Client to send advertisement/embedded email messages 36. It is envisioned that the modification program is executed like an overlay application, which launches every time the Email Client is launched by the Partner's computer. Thus, the modification program “sits on top of” the existing Email Client, extending the code which makes up the Email Client, not modifying it.

After the Partner's Email Client has been so modified, the next time the Partner 24 hits his/her “Send” button 14, HTML code, with appropriate scripts that can be understood by most modern HTML interpreters existing in today's email clients, is dynamically embedded in the outgoing email message 36. This code is comprised of the Partner's affiliate I.D. No. 40 (assigned to them upon signing up with the Proprietor and downloading the Email Client modification program). Other Email Client objects 38 (for example, Recipient's email address, “Subject” line, time of day, geographic location, i.e., Internet protocol or “IP” address), and/or a profile of the Partner 24 can also be included with the embedded HTML code.

The Recipient 28 receives the email message 36 consisting of the HTML code and the Partner's original message in the Recipient's inbox. Upon the email being opened by the Recipient 28, the HTML interpreter in the Recipient's Email Client reads the HTML code that was embedded by the Partner's Email Client. This causes the affiliate I.D. No. 40, along with other Email Client objects 38, to be sent to the Banner Server 26.

The Banner Server 26 acknowledges the request from Recipient 28 and fetches the appropriate advertising banner 22, which is then displayed in the Recipient message field 20b of the Recipient Email Client message window 10b, preferably above the salutation, as shown in FIG. 4. This is a presently preferred methodology for inserting the advertising banner 22 in the Recipient message field 20b.

The Banner Server 26 is constructed, maintained, and hosted by the Proprietor at a location remote from either the Partner 24 or the Recipient 28 (connected by the Internet and/or an Intranet system), as will be apparent to those skilled in the art.

In addition to simply inserting the advertising banner 22, the Banner Server 26 performs other functions. For example, as noted above, the advertising banner 22 can also be sent with an active link (URL), which allows the Recipient 28 to click on the advertising banner 22, which in turn opens up the Recipient's Internet browser with the advertisement's specified link (i.e., the web page for the company selling the products or services referenced in the ad). This link can also have an additional affiliate I.D. No. 40, separate from that referring to the Partner 24; the additional affiliate I.D. No. 40 referencing the Proprietor, so that the advertiser may know which advertising source provided the referral.

Referring to FIG. 5, the Banner Server may further comprise a web server 30, which processes all input/output data on the Banner Server's data ports. The web server 30 also receives data from the Recipient's computer once the Recipient's 28 email message 36 is opened. The web server 30 also performs a function of sending data to the Recipient's computer, comprised of an advertising medium in the form of a graphic (e.g., JPEG file), streaming multimedia (audio/video), etc.

An application server 32 acts as an intermediary between the Recipient's Email Client, web server 30, and appropriate database information located in a database backend 34. Particularly, the web server 30 passes the affiliate I.D. No. 40, Email Client objects 38, etc., to the application server 32. The application server 32 then passes the appropriate queries and entries to the database backend 34, thereby, among other functions, fetching and inserting the appropriate advertisement from the database backend 34, and instructing the web server 30 to then send the advertisement to the Recipient 28 (to be displayed in the message field 20b).

For example, assume that the Recipient's email address 42 is joe@university.edu, as shown in FIG. 3. Therefore, an Email Client object 38 referenced as “recipient's email address” is the email address joe@university.edu. The resultant email message 36 sent by the Partner 24 would comprise the affiliate I.D. No. 40, the Email Client object 38 joe@university.edu, and the actual text. After receiving and opening the email message 36, the Recipient's Email Client, among other things, sends the Email Client object 38 to the Banner Server 26. The application server 32 of Banner Server 26 would then parse the email address and determine from the .edu email address suffix that the Recipient 28 is most likely a student (or perhaps a professor). The application server 32 would then create the proper query to be sent to database backend 34, which would return an advertisement relating to educational material, as this is most likely something that interests the Recipient 28. In this instance, database backend 34 returns an advertising banner 22 for an online book merchant. The application server 32 would properly format the advertisement (e.g., JPEG graphic), add an active link to it, etc., and then send it via the web server 30 to the Recipient to then be displayed in the Recipient message field 20b of the Recipient Email Client message window lob, as shown in FIG. 4.

The database backend 34 might also keep a log of how many times an advertising banner 22 is pulled and viewed and which Partners 24 sent it. Such a log might also track at least the email addresses of the Recipients 28 viewing the advertising banner 22.

The application server 32 may also work in conjunction with billing software, to generate the appropriate bills for the advertisers whose advertisements are placed, to generate various reports, etc. The application server 32 may be constructed using Cold Fusion, “JRUN” for Java platforms, “ASP” for Microsoft platforms, or “PHP” for Linux platforms. The database backend 34 may be constructed utilizing Oracle, SQL, or DB2.

The web server 30 may utilize the C++ programming language, Pearl scripts, Visual Basic, or equivalent technologies.

With respect to executing and controlling the revenue generation aspects of the system according to the invention, software in communication with the application server 32 may be configured to limit the application server 32 from pulling advertising banners 22 more times than have previously been paid for by advertisers. Particularly, it is envisioned that advertisers will pay a set fee for a certain number of “views” of their advertising banner 22, so that software counters may be utilized to prevent the application server 32 from pulling the advertising banner 22 after the paid-for number of views has already taken place.

Furthermore, to avoid abuse by the Partners 24, e.g., if a Partner 24 decides to “spam” simply to increase the views to the Partner, similar software counters can be utilized in conjunction with the application server 32, to keep track of and limit the number of times the same Recipient 28 sees the same ad. For example, the Partner 24 may be paid a set fee for each unique user viewing a unique advertisement, up to a certain maximum amount per month. Particularly, the application server 32, in conjunction with tracking software and database backend 34, might be configured to credit the Partner 24 (by referencing their unique affiliate I.D. No. 40) for each time the advertising banners 22 are viewed by a unique Recipient 28. Particularly, a Partner's advertising counter record is incremented by one for each unique ad viewed by a Recipient 28. At the end of each month, the counter's value is multiplied by the amount to be paid by unique viewer and unique advertisement, and the application server 32 thus instructs billing software to generate a payment, either in the form of electronic payment (in cash or some other form of compensation) or printed check, to the Partner 24, accordingly.

A further option, with respect to the software program that modifies the Partner's Email Client, is to construct such a program so that the Email Client displays on the Partner's Email Client message window 10a, a second “Send” button (not shown) which is specific to the function of sending the email message with the embedded advertisement. Thus, the Partner 24 may have a choice as to whether or not to send an ad, according to the invention, with the email message. Such a second button might display the text “Ad Send” instead of just “Send.”

It should also be noted that the invention may be utilized in connection with wireless email message devices, for example, by utilizing WDMA technology.

It is also envisioned that the instant invention may be adapted for use in connection with instant messaging.

Another important consideration, with respect to the present invention, is to ensure that the HTML code embedded within the email message 36 sent from the Partner 24 is suited to get through various types of “firewalls” which may be blocking Recipient's Email Client from accessing certain Internet sites. Aware of this concern, those skilled in the art will understand the measures necessary to accomplish this function, in light of the above description.

As an alternative to the preferred embodiments of the method and system of the present invention described above, the system may be configured so that the Partner's Email Client is modified to first contact the Banner Server 26 to retrieve the advertising banner 22, prior to sending the email message 36. Thus, in this alternative, the Recipient 28 would not contact the Banner Server 26 to “pull” the advertising banner 22. Rather, the advertising banner 22 would be “pushed” directly from the Partner 24 to the Recipient 28.

To carry out this alternative, the software downloaded by the Partner 24 from the Proprietor's web site extends the code of the Partner's Email Client to first connect to the Banner Server 26, then transmit the affiliate I.D. No. 40, the Email Client object 38, etc., then receive a binary version of the advertisement (e.g., in SMTP compliant format) from the Banner Server 26, then attach the advertising banner 22 in the outgoing email message 36, and finally send the email message 36 to the Recipient 28. A disadvantage with this alternative is that the advertising banner 22 could not be made “clickable” as described above in connection with the first embodiment. Other disadvantages are that this alternative method is more technically complicated and is more subject to defeat by “firewall” protections at the Recipient's end.

Other variations and modifications of the present invention will be apparent to those skilled in the art, upon reading the above disclosure. It is intended that such variations, equivalents, and modifications be included within the scope of the present invention.

I claim:

1. A system for delivering email-based advertising to discrete users, comprising:
(a) a first computer connected to a computer network, the first computer configured to transmit an email message;
(b) a second computer connected to the computer network, the second computer configured to receive the email message from the first computer, the second computer responsive to the email message, at least one of the first and second computers being configured to transmit identification data and optionally one or more email client objects; and
(c) at least one server in the computer network, the server configured to receive the identification data and optionally one or more of the email client objects, the server being responsive to the identification data and optionally one or more of the email client objects, by selecting an advertisement, the server configured to transmit the advertisement to the first or second computer, so that the second computer may display the advertisement in a text window of the email message.

2. The system of claim 1, wherein the first computer includes a first email client, the first email client configured to embed HTML code into the email message.

3. The system of claim 2, wherein the email message is comprised of the HTML code, the HTML code comprised of the identification data and optionally one or more of the email client objects.

4. The system of claim 3, wherein the affiliate I.D. number identifies a partner, the partner being a user of the first computer system.

5. The system of claim 4, wherein the email client objects comprise at least one of the following:
(a) a recipient's email address;
(b) a subject line;
(c) a time of the day;
(d) an IP address; and
(e) a profile of the partner.

6. The system of claim 1, wherein the second computer is comprised of a second email client, the second email client comprised of an HTML interpreter, the HTML interpreter configured to interpret the HTML code.

7. The system of claim 6, wherein the identification data and optionally one or more of the email client objects are read from the HTML code.

8. The system of claim 1, wherein the identification data and optionally one or more of the email client objects is transmitted to the server by the second computer.

9. The system of claim 1, wherein the server is a banner server, the banner server is programmed to select an appropriate advertisement as a function of the identification data and optionally one or more of the email client objects.

10. The system of claim 9, wherein the banner server is comprised of at least the following:
(a) a web server;
(b) an application server; and
(c) a database backend.

11. The system of claim 10, wherein the server is configured to provide an advertisement and optionally an active link associated with the advertisement, to be transmitted to the second computer.

12. The system of claim 1, wherein the first computer and the second computer are configured to utilize instant messaging software or wireless communication software to communicate email messages to and from each other.

13. A method of delivering email-based advertising between a first computer and a second computer on a network, the method comprising the steps of:
(a) transmitting (by either the first computer or the second computer) identification data and optionally one or more email client objects to a server on the network;
(b) receiving in the server, the identification data and optionally one or more of the email client objects;
(c) selecting an advertisement by means of the server;
(d) transmitting the advertisement to the second computer; and
(e) embedding the advertisement in a text window of an email message, to be displayed on a screen of the second computer.

14. The method of claim 13, wherein the email message is sent from the first computer to the second computer and the identification data, and optionally one or more email client objects is sent from the second computer to the server.

15. The method of claim 14, wherein the server selects an advertisement, based on the identification data and optionally one or more of the email client objects, and sends an advertisement to the second computer, wherein the second computer then attaches the advertisement to the email message so that the advertisement appears in the text window of the email message.

16. The method of claim 13, wherein the identification data is an affiliate I.D. number and the optional email client objects include at least a subject line.

17. The method of claim 13, wherein the server counts the number of times a particular ad is pulled and sent for attachment to an email message.

18. The method of claim 13, wherein the server utilizes counting software to limit the number of times a particular recipient of an email message sees the same ad.

19. The method of claim 13, wherein the server credits a partner, with reference to the identification data, for each time an advertisement is viewed by a unique recipient.

20. The method of claim 19, wherein the server instructs billing software to generate a payment, either in the form of electronic payment or printed check, to a partner based on the number of advertisements placed by the server in connection with that partner's identification data.

21. The method of claim 13, wherein the server works in conjunction with billing software to generate bills for advertisers whose advertisements are placed by the server, based on the number of times the advertisements are sent from the server for attachment to an email message.

22. The method of claim 13 wherein, in addition to the advertisement, the server sends an active link (URL) to enable a recipient to click on the advertisement and access the advertiser's website.
